(19) United States
(12) Patent Application Publication
(10) Pub. No.: US 2010/0000587 A1
(43) Pub. Date: Jan. 7, 2010

(54) PORTABLE FOOD WASHER

(76) Inventor: Sharon K. Lemon, North Canton, OH (US)

Correspondence Address: FRED ZOLLINGER III, P.O. BOX 2368, NORTH CANTON, OH, 44720, US

(21) Appl. No.: 12/493,175

(22) Filed: Jun. 27, 2009

Related U.S. Application Data
(60) Provisional application No. 61/076,231, filed on Jun. 27, 2008.

(51) Int. Cl. B08B 3/00

(52) U.S. Cl. 134/56 R

(57) ABSTRACT

A portable food washer may be used in any kitchen with a standard kitchen sink. The food washer includes a chamber adapted to receive food between a first and second wash water spray sources. The spray sources are connected to a wash water supply line that may be selectively connected to a kitchen faucet. A timer is used to control the supply of water to the wash water spray sources. A cleaning solution reservoir may be used to supply a produce cleaning agent to the streams of wash water. The user may place the food on a rack between the spray sources, turn the water source on, and set the timer for the appropriate amount of time for the produce being washed. The washer then functions until the timer shuts down the spray sources or until the water is turned off.

### CROSS REFERENCE TO RELATED APPLICATIONS

This application claims the benefit of U.S. Provisional Application Ser. No. 61/076,231 filed Jun. 27, 2008; the disclosures of which are incorporated herein by reference.

### BACKGROUND OF THE INVENTION

1. Technical Field

The present invention generally relates to devices to wash food and, more particularly, to a portable food washer that may be selectively connected to a kitchen sink faucet to provide the wash water. Specifically, the invention relates to a portable food washer having a timer that controls the wash time, a reservoir for a cleaning solution, a pair of wash water spray sources, and a self contained, portable body that obtains wash water from a sink faucet and expels waste water into a kitchen sink.

2. Background Information

Despite years of common knowledge that fresh fruits and vegetables should be washed before use, many home cooks skip the washing step completely or quickly wash the produce under cool tap water before use. In recent years, national food alerts have raised awareness of the need to thoroughly wash produce before use in order to minimize the risk of illness attributed to contaminated produce. Unfortunately, busy cooks hesitate to take the time to properly and thoroughly wash produce because of the time and hassle. Further, although soft-bristle produce brushes are available in the market, most cooks do not have the proper equipment to thoroughly wash their produce. As a result, many cooks do not properly clean their produce at home thus placing themselves and their families at an increased risk of contracting an illness from contamination on the outside of everyday produce.

### SUMMARY OF THE INVENTION

The invention provides a portable food washer that may be used in any kitchen with a standard kitchen sink. The food washer includes a chamber adapted to receive food between a first and second wash water spray sources that wash the food from the top and bottom directions. The spray sources are connected to a wash water supply line that may be selectively connected to a kitchen faucet. A timer is used to control the supply of water to the wash water spray sources. A cleaning solution reservoir may be used to supply a produce cleaning agent to the streams of wash water. The user may place the food on a rack between the spray sources, turn the water source on, and set the timer for the appropriate amount of time for the produce being washed. The washer then functions until the timer shuts down the spray sources. The washer is water-powered and does not require electricity.

The food washer fits in most kitchen sinks and drains directly into the sinks to minimize cleanup.

The housing may be transparent or translucent to allow the user to see the cleaning action.

In one configuration, the invention provides a housing having a base and a hinged lid. When the lid is closed, the unit is water tight so that it will not leak onto the counter or table on which it is placed during use. One spray source is disposed on the inner surface of the bottom of the base with another spray source disposed on the inner surface of the lid. The spray sources face each other when the lid is closed. A produce rack is removably carried by the base and is disposed between the spray sources when the lid is closed. A wash water supply line enters the chamber of the washer through the side of the lid, passes through a timer, and is fluid communication with both spray sources. A cleaning solution reservoir is in fluid communication with the wash water supply line between the timer and the spray sources so that a cleaning agent from the reservoir may be equally delivered to both spray sources. A fill opening is disposed through the top of the lid so that cleaning agent may be added to the reservoir while the lid is closed.

The invention provides one configuration of a portable food washer having a lid hinged to a base with a horizontal hinge. A wash water supply line enters the lid on the hinge side and extends across the length of the lid to a water-powered timer. The wash water supply line then extends back across the length of the lid where it extends down across the hinge to supply the lower spray source. The weight of the wash water supply line and the timer in the lid helps keep the washer closed during operation. An optional cleaning agent reservoir may be carried by the lid.

### BRIEF DESCRIPTION OF THE DRAWINGS

FIG. 1 is a front perspective view of a first exemplary configuration of the portable food washer.

FIG. 2 is a section view taken through the first exemplary configuration of the portable food washer.

FIG. 3 is a front schematic elevation view of a second configuration of the portable food washer.

FIG. 4 is a right side schematic view of the second configuration of the portable food washer.

FIG. 5 is a top schematic view of the second configuration of the portable food washer.

The drawings are not to scale. Similar numbers refer to similar parts through the specification.

### DETAILED DESCRIPTION OF THE INVENTION

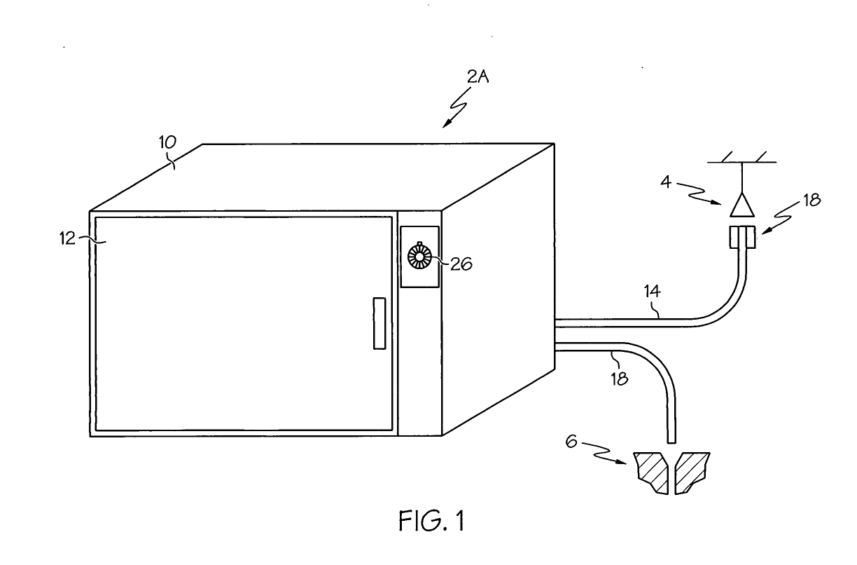

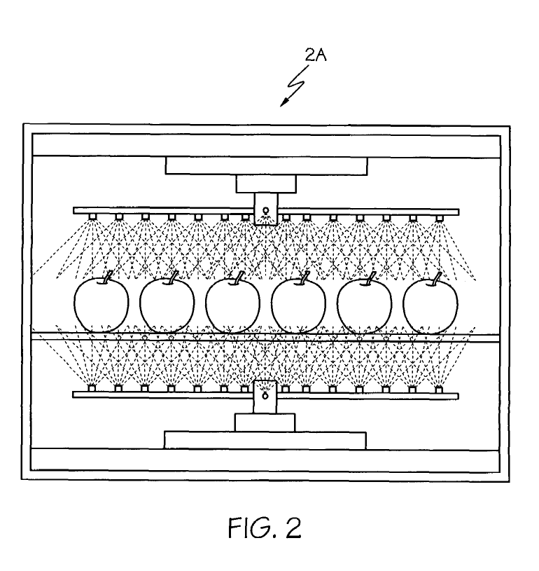

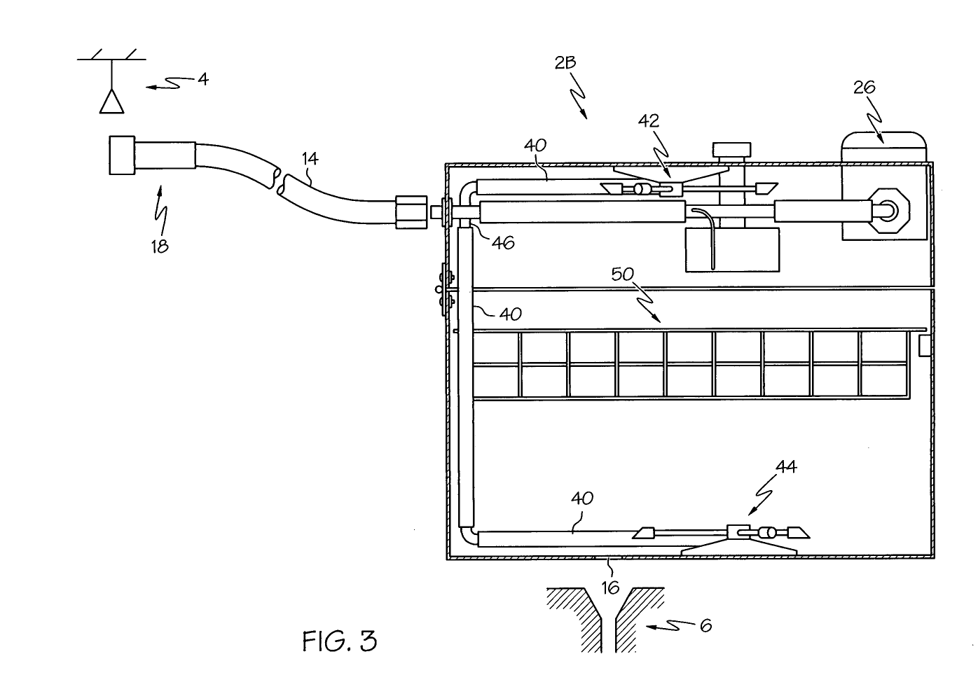

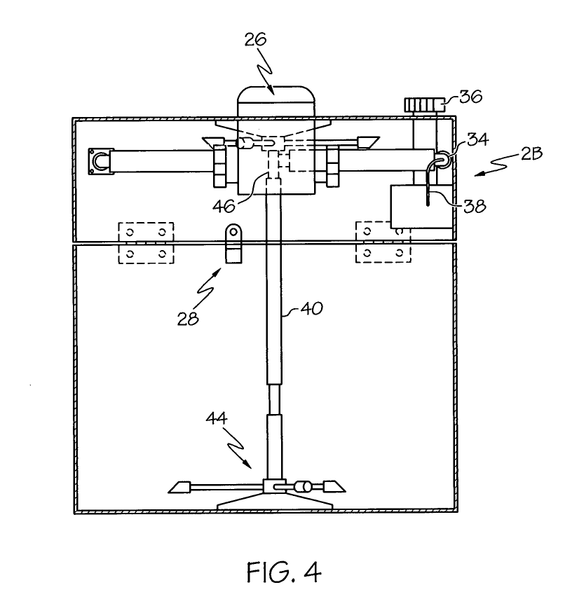

The first configuration of the portable food washer of the invention is indicated generally by the reference numeral 2A in FIGS. 1 and 2. The second configuration of the portable food washer is indicated generally by the reference numeral 2B in FIGS. 3-5. In this specification, the reference numeral 2 is used to refer to both the first and second configurations of the portable food washer. Portable food washer 2 is used to expose food such as produce to a wash spray that may optionally contain a cleaning agent in order to remove contaminates from the exterior of the produce. Portable food washer 2 may be used with a common kitchen sink faucet 4 as a wash water supply and a common kitchen sink drain 6 to dispose the waste water.

Portable food washer 2 generally includes a body having a base 10 and a lid 12 that is hinged to base 10 and movable between open and closed positions. A seal may be used between base 10 and lid 12 to prevent water from exiting the body from the joint between base 10 and lid 12. Portable food washer 2A has lid 12 disposed on the front of base 10 so that lid 12 pivots on a vertical axis and opens like a typical microwave oven door. Portable food washer 2B has lid 12 positioned on the top of base 10 so that lid 12 pivots on a horizontal axis and opens like the lid of a portable cooler. The body may be fabricated from a transparent or semi-transparent material (such as a plastic or a glass) so that the user can view the washing process from the outside of the body.

Portable food washer 2 includes a wash water supply line 14 and a drain 16 for the waste water. The bottom wall of the washer may be sloped toward drain 16. An optional drain line 18 may be provided when portable food washer 2 is used on a counter next to sink drain 6. When portable food washer 2 is used directly in or above sink drain 6, drain 16 may be disposed in the bottom wall of base 10. A faucet attachment 18 is connected to the distal end of wash water supply line 14 to allow line 14 to be readily connected to kitchen sink faucet 4 without the need for tools. Such an attachment 18 may be the type used on portable dishwashers. In the second configuration of portable food washer 2B, wash water supply line 14 enters through lid 12 on the same side of lid 12 as the hinges 20 that are used to hingedly connect lid 12 to base 10. A pass-through fitting 22 is used to allow the wash water to flow through the sidewall of lid 12 without leaking.

Once inside lid 12, a timer supply line 24 is used to deliver the wash water to a timer 26. Timer 26 is a mechanical timer that does not require electricity to function. One example of a timer that may be used is model number 3010 by Melnor, Inc. of Winchester, Va. Timer 26 is configured to function with low pressure operations and measures time (not water volume). When the timer winds down to zero, it stops the water flow like a faucet. The top of timer 26 protrudes through the body so that it may be activated and viewed from the outside of body. In the first configuration of portable food washer 2A, the top of timer 26 protrudes through the front of the body. In the second configuration of portable food washer 2A, the top of timer 26 protrudes through the top of the body on the side of lid 12 opposite hinges 20. The weight of timer 26 helps to close lid 12 against base 10 so that a latch is not necessary to maintain lid 12 closed during use. Portable food washer 2B is configured to locate most of the components in lid 12 to add weight to lid 12 so that lid 12 stay tight against base 10 when lid 12 is closed. A latch 28, however, may be optionally positioned opposite hinges 20 to secure lid 12 to base 10 with a tight fit.

A reservoir supply line 30 provides fluid communication between timer 26 and a cleaning solution reservoir 32. Reservoir 32 allows the user to selectively add a cleaning agent to the wash water supply. Reservoir 32 includes a valve 34 that allows the user to adjust the amount of cleaning agent being supplied to the supply of wash water. Valve 34 allows the supply to be completely turned off or turned on to a maximum amount. A cleaning agent fill line 36 is disposed through lid 12 to allow the user to fill reservoir 32 without opening lid 12. A small flexible supply pipe 38 is connected to the wash water supply line to pull cleaning agent into the wash water.

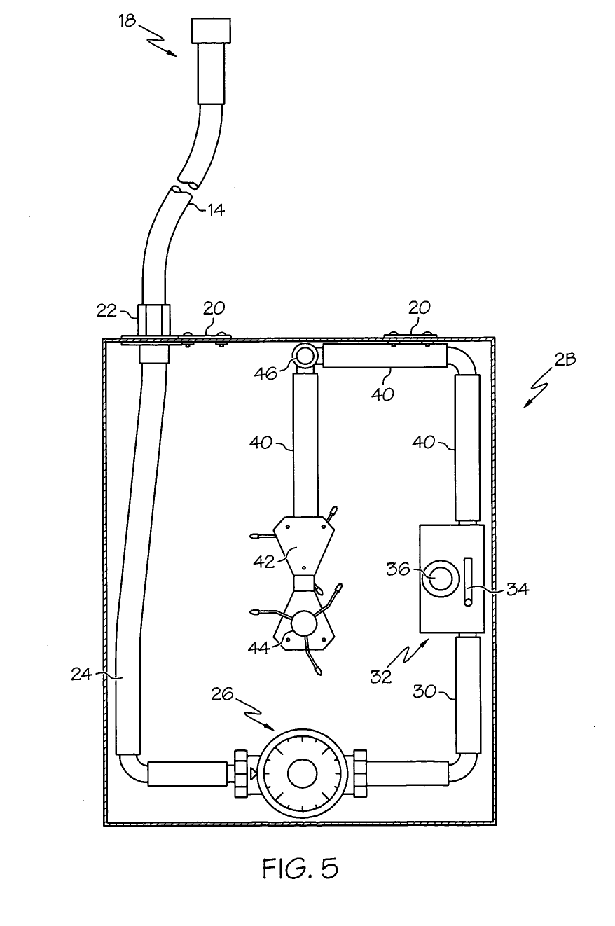

A spray source supply line 40 provides fluid communication between reservoir 32 and first 42 and second 44 spray sources. Line 40 extends back to the hinge side of lid 12 so that the portion of line that extends down over the joint between lid 12 and base 10 bends a minimal amount when lid 12 is opened and closed. The portion of line 40 at the joint is flexible and includes extra length so that lid 12 may be opened and closed without damaging line 40. Line 40 includes a T-joint 46 that distributed the wash water substantially evenly to both spray sources 42 and 44. Each spray source 42 and 44 may be stationary or may be of the type that spins. Small lawn sprinkler heads may be used as sources 42 and 44. FIG. 5 shows that sources 42 and 44 are offset so that the spray patterns from each will impact the food at different locations.

A produce basket 50 is removable carried by base 10 between spray sources 42 and 44. Basket 50 defines a plurality of openings to allow the wash water to impact against the produce carried by basket 50. A coated wire frame basket may be used for basket 50.

Portable food washer 2 may be used by opening lid 12, placing food in basket 50 and closing lid 12 so that the food is positioned between spray sources 42 and 44. After supply line 14 is connected to a source of water, the user sets timer 26 to an appropriate time for the food being washed. The timer will provide wash water to spray sources 42 and 44 for the selected time while the user performs other tasks. When the time is done, the timer automatically turns of the wash water supply and the user may remove the food.

The elements of the configurations described above may be interchanged to create further configurations. In the foregoing description, certain terms have been used for brevity, clearness, and understanding. No unnecessary limitations are to be implied therefrom beyond the requirement of the prior art because such terms are used for descriptive purposes and are intended to be broadly construed. The term “includes” is intended to have the same non-limited meaning as the term “comprises.” Moreover, the description and illustration of the invention is an example and the invention is not limited to the exact details shown or described.

1. A portable food washer for use with a standard kitchen sink; the food washer comprising:
a body having a chamber adapted to receive food between first and second wash water spray sources;
each of the wash water spray sources being connected to a wash water supply line adapted to be selectively connected to a kitchen faucet; and
a timer that controls the supply of water to the wash water spray sources.

2. The food washer of claim 1 further comprising a cleaning solution reservoir that may be used to supply a produce cleaning agent to the streams of wash water.

3. The food washer of claim 1, wherein the timer is mechanical and does not require electricity.

4. The food washer of claim 1, wherein the wash water spray sources are water-powered spinning type spray heads.

5. The food washer of claim 1, wherein the body has a base and a lid connected to the base with a hinge; the timer being carried by the lid opposite the hinge.

6. The food washer of claim 1, wherein the body has a base and a lid connected to the lid with a hinge; the first wash water spray source being carried by the lid and the second wash water spray source being carried by the base.

7. The food washer of claim 6, wherein the first and second wash water spray sources face each other.

8. The food washer of claim 7, wherein the first and second wash water spray sources are offset from one another.

9. The food washer of claim 1, further comprising a removable food support structure carried by the body between the first and second wash water spray sources.

10. A portable food washer for use with a standard kitchen sink; the food washer comprising:
a base;
a lid connected to the base with a hinge; the lid being movable between open and closed conditions; the lid and base defining a chamber when the lid is in the closed condition;
the lid having a first side where the lid is connected to the base with the hinge; the lid having a second side opposite to where the lid is connected to the base with the hinge;
a first wash water spray source carried by the lid;
a second wash water spray source carried by the base;
the first and second wash water spray sources facing each other;
a removable food support structure disposed between the first and second wash water spray sources;
each of the wash water spray sources being connected to a wash water supply line adapted to be selectively connected to a kitchen faucet;
a timer that controls the supply of water to the wash water spray sources; the timer being carried by the lid opposite the hinge; and
the wash water supply line entering the chamber through the first side of the lid, extending across the lid to the timer, and having a portion that extends back across the lid to a location near the first side of the lid, and then crossing the hinge to supply the second wash water spray source.

11. The food washer of claim 10, wherein the first and second wash water spray sources are offset from one another.

12. The food washer of claim 10, wherein the removable food support structure is a basket.

13. The food washer of claim 10, further comprising a cleaning solution reservoir connected to the wash water supply line.

14. The food washer of claim 10, wherein the timer is mechanical and does not require electricity.

15. The food washer of claim 10, wherein the wash water spray sources are water-powered spinning type spray heads.
